(19) United States
(12) Patent Application Publication
(10) Pub. No.: US 2002/0153675 A1
(43) Pub. Date: Oct. 24, 2002

(54) Chuck for rotary tools

(76) Inventors: Rory Neil Adams, Charlestown, NH (US); Kevin B. Smith, Harrisville, NH (US)

Correspondence Address: H. Duane Switzer, Jones, Day, Reavis & Pogue, North Point, 901 Lakeside Avenue, Cleveland, OH, 44114, US

(21) Appl. No.: 09/837,680

(22) Filed: Apr. 18, 2001

(51) Int. Cl. B23B 31/20

(52) U.S. Cl. 279/51; 279/54; 279/58; 433/129

(57) ABSTRACT

A chuck having a pair of opposed clamp pads, each pad engaging a tool shank at sharp corners along a pair of angularly-spaced lines of contact. Tapered outer surfaces on the clamp pads are crowned to engage a cooperating taper on a sleeve at the midpoint between the opposite ends of a pad. The clamp pads are carried by a guide bushing that reciprocates within a shaft bore to provide movement of the clamp pads inwardly or outwardly.

### BACKGROUND OF THE INVENTION

This application relates to the art of chucks and, more particularly, to chucks for rotary tools. The invention is particularly applicable to chucks for dental handpieces and will be described with specific reference thereto. However, it will be appreciated that the invention has broader aspects and can be used with other devices.

Chucks for holding dental tools in a handpiece often are very complicated and have numerous parts so that manufacture and assembly are difficult. Many chucks do not automatically compensate for wear or for small discrepancies in the fit between parts, and this results in less than optimum clamping force on a tool that is held by the chuck.

### SUMMARY OF THE INVENTION

A chuck for dental handpieces has a pair of opposed clamp pads that can move radially inwardly or outwardly responsive to axial movement of a guide bushing that carries the clamp pads.

The clamp pads have axially extending opposed arcuate grooves that receive a cylindrical shank on a dental tool. The arcuate grooves are curved on a cylinder having a diameter smaller than the diameter of the shank on the tool so that each clamp pad makes line contact with a tool shank at two angularly-spaced locations.

An external taper on the clamp pads is outwardly crowned in a direction between the opposite pad ends. The midpoint of the crowned taper between the pad ends is tangent to a cooperating taper within a sleeve that receives the guide bushing. This compensates for angular errors in production of the components, and provides consistent and improved contact between the cooperating tapers and between the clamp pads and the tool shank.

The arcuate axial grooves in the clamp pads extend over less than 180°. The arcuate grooves are segments of a cylindrical bore and are formed by taking a chord through the cylinder. Varying the distance of the chord from the center of the cylinder varies the length of the chord as well as the arcuate segment. This makes it possible to customize the spacing of the lines of contact between the clamp pads and the tool shank.

It is a principal object of the invention to provide an improved chuck for dental handpieces.

It is another object of the invention to provide a chuck that compensates for angular errors in production.

It is also an object of the invention to provide a chuck that provides improved consistent contact between cooperating tapers and between clamp pads and a tool shank.

### BRIEF DESCRIPTION OF THE DRAWING

FIG. 1 is a cross-sectional elevational view of a chuck in accordance with the present application;

FIG. 2 is a cross-sectional elevational view of a shaft used in the chuck of FIG. 1;

FIG. 3 is perspective illustration of a guide bushing used in the chuck of FIG. 1;

FIG. 4 is a side elevational view of a guide bushing used in the chuck of FIG. 1;

FIG. 5 is a cross-sectional elevational view taken generally on line 5-5 of FIG. 4;

FIG. 6 is a side elevational view of one clamp pad used in the chuck of FIG. 1;

FIG. 7 is a plan view showing the inside of the clamp pad;

FIG. 8 is an end view of the clamp pad;

FIG. 9 is an enlarged partial end view of a clamp pad;

FIG. 10 is an end elevational view showing line contact between a dental tool shank and the surface of an arcuate groove in a clamp pad at two angularly-spaced locations; and

FIG. 11 is a cross-sectional elevational view of a sleeve used in the chuck of FIG. 1.

### DESCRIPTION OF A PREFERRED EMBODIMENT

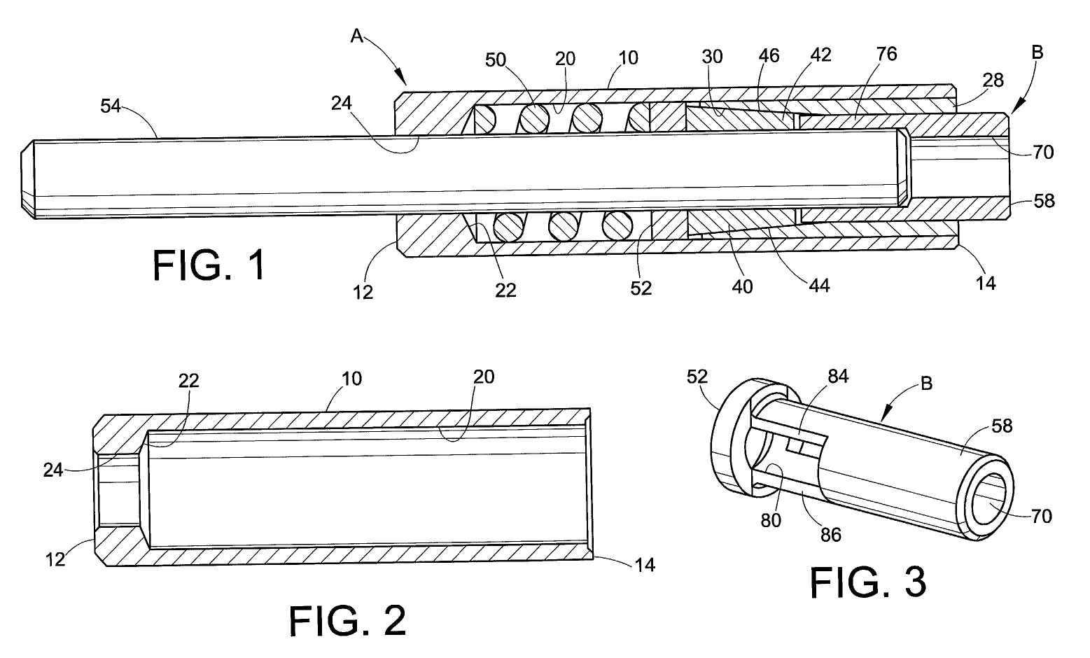

Referring now to the drawing, wherein the showings are for purposes of illustrating a preferred embodiment of the invention only and not for purposes of limiting same, FIG. 1 shows a chuck A including an elongated cylindrical shaft 10 having front and rear ends 12, 14.

A central cylindrical bore 20 extends into shaft 10 from rear end 14 thereof and terminates at a bore bottom 22 adjacent front end 12. A central cylindrical hole 24 having a diameter smaller than the diameter of bore 20 extends into shaft 10 from front end 12 thereof. Hole 24 intersects and is surrounded by bore bottom 22.

A sleeve 28 is received in bore 20 from shaft rear end 14 and is spaced from bore bottom 22. Sleeve 28 includes an internal taper 30 that lies on the surface of a cone and faces in a direction toward shaft front end 12.

A guide bushing B is slidably received within sleeve 28 for axial movement relative thereto. Guide bushing B carries a pair of opposite clamp pads 40, 42 having tapered outer surfaces 44, 46 that cooperate with sleeve taper 30.

A coil spring 50 positioned within bore 20 acts between bore bottom 22 and guide bushing head 52 to normally bias guide bushing B in a direction away from shaft front end 12. In that biasing direction, sleeve taper 30 and clamp pad tapers 44, 46 cooperate to move clamp pads 40, 42 radially inwardly to grip a cylindrical shank on a rotary tool. FIG. 1 shows the clamp pads gripping a cylindrical plug 54. It will be recognized that cylindrical plug 54 is replaced with a suitable tool having a cylindrical mounting shank gripped by the clamp pads and a tool on its working end. Different types of dental tools typically are used for cutting, drilling, grinding or polishing.

A release projection 58 on guide bushing B extends outwardly from shaft rear end 14 for engagement by a button on a dental handpiece. Pushing on the button moves guide bushing B in a direction toward shaft front end 12 against the biasing force of spring 50. In this direction of movement of guide bushing B, clamp pads 40, 42 may move radially outwardly for inserting a tool shank or for releasing a tool shank therefrom so that the tool can be withdrawn from the chuck.

With reference to FIGS. 3-5, guide bushing B has a central cylindrical bore 64 extending therein from guide bushing head 52. A chamfer 68 is provided at the entrance opening to guide bushing bore 64 on the outer surface of head 52 to facilitate insertion of a tool shank into bore 64. Tool shank receiving bore 64 intersects a smaller diameter through hole 70 at a shoulder 72. The end of the shank on a tool typically bottoms out against shoulder 72.

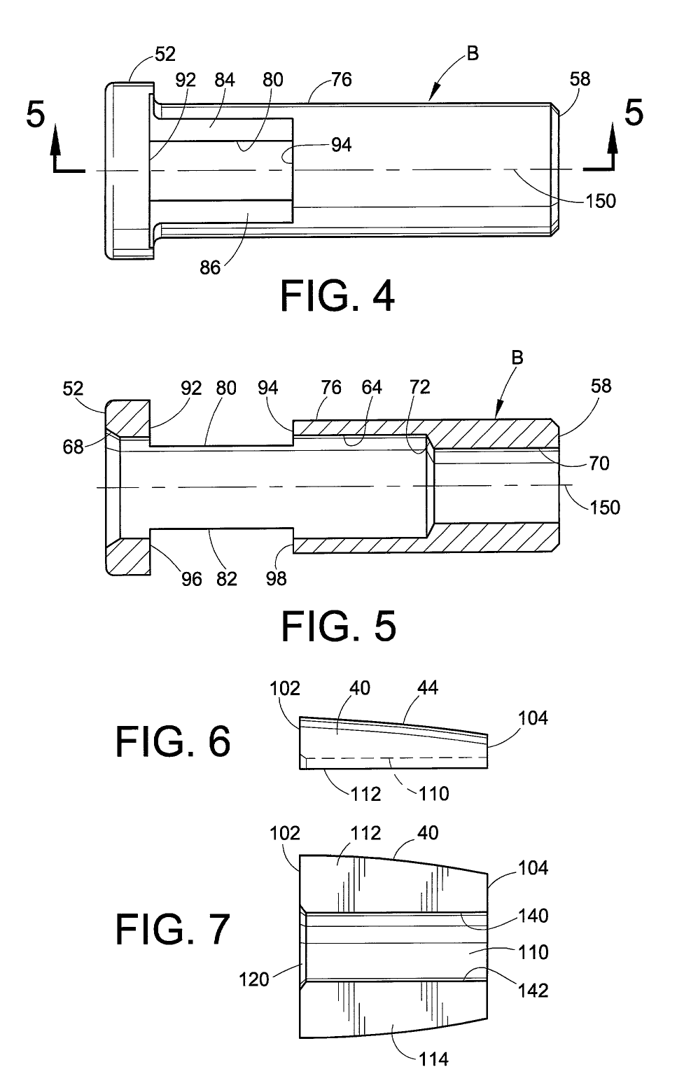

Cylindrical guide bushing stem 76 has a pair of opposite rectangular openings 80, 82 therethrough intersecting bore 64 adjacent head 52. Guide bushing shank 76 has flat surfaces on opposite sides of each opening 80, 82 that lie on a chord of a circle having the same diameter as the external cylindrical surface of guide bushing stem 76. Those flat surfaces are shown at 84 and 86 in FIG. 4 for opening 80, and it will be appreciated that corresponding flat surfaces are provided on opposite sides of rectangular opening 82.

Formation of cutouts or openings 80, 82 provides axially-spaced opposed abutment surfaces 92, 94 and 96, 98 that cooperate with the opposite ends of the clamp pads when the clamp pads are positioned within openings 80, 82. The length of each opening 80, 82 is greater than the length of each clamp pad 40, 42 so that the clamp pads are relatively loose and free to float within the openings.

FIGS. 6-9 show a clamp pad 40, and it will be recognized that the opposite clamp pad 42 is identical. Clamp pad 40 has opposite large and small ends 102, 104. Outer tapered surface 44 also is outwardly crowned in a direction between opposite ends 102, 104 so that the outer surface is tangent to sleeve taper 30 at the approximate midpoint of the clamp pad between its opposite ends 102, 104. This compensates for small angular errors in production of the components to provide consistent and improved contact between the sliding tapered surfaces. This also enhances contact with the shank of the tool to provide improved clamping performance and reliability.

The inside surface of clamp pad 40 opposite from tapered surface 44 has a central arcuate groove 110 therein. Arcuate groove 110 has a surface that lies on the periphery of a cylinder that is parallel to the longitudinal axis of chuck A in FIG. 1.

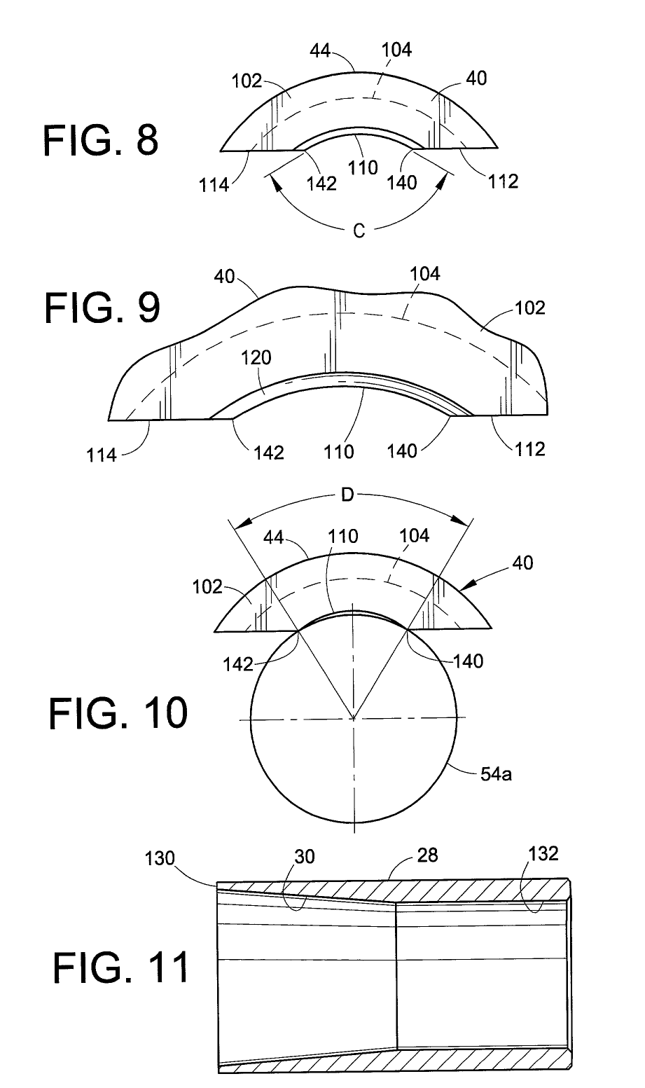

Plane surfaces 112, 114 on opposite sides of arcuate groove 110 lie on a chord of a circle having a diameter the same as the diameter of the cylinder on which the surface of arcuate groove 110 lies. In the arrangement shown in FIG. 8, the chord is such that arcuate groove 110 extends over an angle C of approximately 120 degrees. It will be recognized that other chords may be used so that the angle would be greater or lesser than 120 degrees depending upon the application.

By way of example, the included angle D in FIG. 10 between corners 140, 142 from the center of a tool shank 54a is approximately 60°.

This angle varies with the length of the chord across the opposite ends of arcuate groove 110 at corners 140, 142. The angle may vary between 40-90°, more preferably between 50-75°, and most preferably between 55-65°.

As shown in FIG. 9, the entrance to arcuate groove 110 at large clamp pad end 102 is chamfered as indicated at 120 to facilitate insertion of a tool shank into the arcuate grooves between a pair of opposed clamp pads. The chamfer may extend over the entire entrance to the arcuate groove between plane surfaces 112, 114.

FIG. 11 shows sleeve 28 as having a small sleeve end 130 that is spaced from guide bushing head 52 within shaft 10 as shown in FIG. 1. Cylindrical hole 132 in sleeve 28 slidably receives cylindrical stem 76 on guide bushing B.

The chuck is assembled by placing clamp pads 40, 42 on guide bushing B, and inserting guide bushing stem into sleeve 28. Spring 50 then is inserted in bore 20 in shaft 10, followed by the assembly of the sleeve, guide bushing and clamp pads. Sleeve 28 then is welded to shaft 10 adjacent rear end 14 thereof with the rear ends of the sleeve and shaft substantially flush.

The arcuate groove or curved segment 110 on a clamp pad 40 intersects plane surfaces 112, 114 on opposite sides of the arcuate groove at sharp corners 140, 142 that are not rounded and extend the length of the clamp pad. The curvature of an arcuate groove is at a smaller radius than the radius of a cylindrical tool shank. By way of example, for a cylindrical tool shank having a diameter of 0.0626-0.0630 inch, each arcuate groove is curved on a cylinder having a diameter of 0.0616-0.0620 inch. Each clamp pad then engages a tool shank along a pair of angularly-spaced lines of contact corresponding to sharp intersection corners 140, 142 as shown in FIG. 10 for tool shank 54a.

The diameter at which arcuate grooves 110 are curved preferably is close to the diameter of a tool shank but slightly smaller. In the example given, the diameter of the cylinder on which an arcuate groove 110 is curved is about 1.6% smaller than the diameter of a tool shank. This may vary as long as line contact is obtained at a pair of angularly-spaced lines of engagement as shown in FIG. 10. The two clamp pads make line contact with a tool shank along four angularly-spaced lines of engagement.

Plane surfaces 112, 114 on a clamp pad 40 may be considered to be on a chord spaced a certain first distance outwardly from the longitudinal axis 150 of guide bushing B. Plane surfaces 84, 86 on opposite sides of an opening 80 in guide bushing B are on a chord spaced a second distance outwardly from longitudinal axis 150 that is smaller than the first distance. Thus, when clamp pad surfaces 112, 114 are placed against guide bushing surfaces 84, 86, the surface of arcuate groove 110 is radially inward of the surface of bore 64 in guide bushing B.

Cooperating tapers 30, 44, 46 on the sleeve and clamp pads are tapered at an angle of 4.5-5.5° to the longitudinal axis of the chuck. For a clamp pad having a length between its opposite ends 102, 104 of 0.0840-0.0860 inch, clamp pad tapers 44, 46 are outwardly crowned at a radius of 0.6098 inch to be tangent to a 5° taper at the midpoint between opposite clamp pad ends 102, 104.

Shaft 10 is mounted in a rotary drive mechanism in a known manner for rotatably driving shaft 10 about its longitudinal axis. Guide bushing projection 58 may be depressed by pressing a button on a dental handpiece to move the clamp pads outwardly for inserting or removing a tool shank. Release of the button automatically moves the guide bushing in the opposite direction by the action of spring 50. At the same time, cooperation between tapered surfaces 30, 44 and 46 on the sleeve and clamp pads moves the clamp pads inwardly into clamping engagement with a tool shank that is positioned between the clamp pads.

At least clamp pad corners 140, 142 preferably are hard coated with a suitable hard coating material such as titanium carbide, titanium nitride, hard chromium or diamond like carbon which is known in the art as DLC. The tapered outside clamp pad surfaces 44, 46 also may be hard coated. Hard coating the contacting corners reduces wear as tools are inserted and removed from the chuck so that the corners do not become rounded prematurely and loose their grip on a tool shank.

The hard coated clamping corners make line contact with a tool shank at two opposed pairs of contact lines. The midpoints between each pair are 180° apart so that the clamping forces oppose one another to securely grip a tool shank.

Although the invention has been shown and described with reference to a preferred embodiment, it is obvious that equivalent alterations and modifications will occur to others skilled in the art upon the reading and understanding of this specification. The present invention includes all such equivalent alterations and modifications, and is limited only by the scope of the claims.

We claim:

1. A chuck having a pair of opposed clamp pads carried by a reciprocal bushing within a sleeve, cooperating tapers between said clamp pads and said sleeve for providing movement of said clamp pads radially inwardly or outwardly responsive to axial movement of said guide bushing, and said clamp pad tapers being crowned to provide tangency with said sleeve taper at a location between the opposite ends of the clamp pads.

2. The chuck of claim 1 wherein said clamp pads have opposed arcuate grooves extending axially thereof for receiving a cylindrical tool shank therebetween, each arcuate recess being a segment of a cylindrical bore and extending over an angle between 40-90°.

3. The chuck of claim 1 wherein said guide bushing includes a cylindrical hollow stem having a pair of opposite openings therein receiving said clamp pads.

4. The chuck of claim 3 wherein said guide bushing includes a head engaged by a spring that biases said guide bushing axially in a direction to move said clamp pads radially inwardly by cooperation between said cooperating tapers.

5. A chuck having a pair of opposed clamp pads, each clamp pad having a pair of angularly-spaced clamping corners that make line contact with a cylindrical tool shank, and said corners being angularly spaced between 40-90°.

6. The chuck of claim 5 wherein at least said clamping corners on said clamp pads are hard coated.

7. The chuck of claim 5 wherein said pair of clamping corners are angularly spaced between 50-75°.

8. The chuck of claim 5 wherein each said clamping surface is a segment of a cylinder and each said clamp pad has plane surfaces on opposite sides of each said segment, said pair of clamping corners being at the intersection of said segment with said plane surfaces.

9. The chuck of claim 5 wherein each said clamp pad has opposite ends and an outer tapered surface that is tapered between said opposite ends, and said tapered surface being outwardly crowned between said opposite ends.

10. A chuck for rotary tools comprising:
a shaft having front and rear ends;
a central cylindrical bore extending into said shaft from said rear end toward said front end and terminating at a shoulder, said bore having a bore bottom;
a central cylindrical hole extending into said shaft from said shaft front end, said hole having a hole diameter smaller than said bore diameter and intersecting said bore radially inwardly of said bore bottom;
a sleeve secured within said bore in axially-spaced relationship to said shoulder, said sleeve having a sleeve taper facing toward said shaft front end;
a guide bushing received in said sleeve for axial movement relative thereto;
a pair of opposite clamp pads carried by said guide bushing, said clamp pads having outer pad tapers engaging said sleeve taper for providing movement of said clamp pads radially inwardly when said guide bushing moves away from said front end and radially outwardly when said guide bushing moves toward said front end;
said clamp pads have opposed inner clamping surfaces between which a tool shank is receivable; and
a spring in said bore between said bore bottom and said guide bushing, said spring normally biasing said guide bushing away from said shaft front end.

11. The chuck of claim 10 wherein said clamp pads have opposite clamp pad ends and said outer pad tapers are crowned between said clamp pad ends.

12. The chuck of claim 10 wherein said clamping surfaces are segments of a cylinder, each segment extending over an arc of 40-90°.

13. The chuck of claim 12 wherein each said clamp pad has plane surfaces on opposite sides of said segment, each said segment intersecting said plane surfaces along intersection corners, and said intersection corners being engageable with a tool shank to provide a pair of angularly spaced lines of engagement between a clamp pad and a tool shank.

14. The chuck of claim 10 wherein each said clamp pad clamps a cylindrical tool shank along a pair of clamping corners that are angularly spaced between 40-90°.

15. The chuck of claim 14 wherein said clamping corners are angularly spaced between 50-75°.

16. The chuck of claim 15 wherein said clamping corners are angularly spaced 55-65°.

17. The chuck of claim 10 wherein said clamping corners are hard coated.
